(19) United States
(12) Patent Application Publication
(10) Pub. No.: US 2007/0239605 A1
(43) Pub. Date: Oct. 11, 2007

(54) Supporting multiple key ladders using a common private key set

(76) Inventors: Peter Munguia, Chandler, AZ (US); Steve J. Brown, Phoenix, AZ (US); Dhiraj Bhatt, Portland, OR (US); Dmitri Loukianov, Chandler, AZ (US)

Correspondence Address: INTEL CORPORATION;c/o INTELLEVATE, LLC, P.O. BOX 52050, MINNEAPOLIS, MN, 55402, US

(21) Appl. No.: 11/399,712

(22) Filed: Apr. 6, 2006

(51) Int. Cl. G06Q 99/00

(52) U.S. Cl. 705/50

(57) ABSTRACT

An apparatus may include circuitry to permanently and inaccessibly store a first private key that is a shared secret between a manufacturer of the circuitry and a first vendor of first encrypted media information. It may also include a key ladder to provide plural layers of encryption to the first private key to generate a first result for decrypting the first encrypted media information. A cryptographic module may encrypt the first private key to generate a second result for a security purpose other than decrypting media information. The module also may include a key ladder, and the apparatus may include other key ladders using the private key.

### CROSS-REFERENCE TO RELATED APPLICATIONS

The present application is related to application Ser. No. ______, entitled “Method And Apparatus To Mate An External Code Image With An On-Chip Private Key” and filed Apr. 7, 2006 (Docket No. P24003); to application Ser. No. ______, entitled “Protecting Independent Vendor Encryption Keys With A Common Silicon Manufacturer's Key” and filed ______ (Docket No. P24005); and to application Ser. No. ______, entitled “Control Word Key Store For Multiple Data Streams” filed Apr. 6, 2006 (Docket No. P24006).

### BACKGROUND

Implementations of the claimed invention generally may relate to security schemes for decrypting encrypted media information and, more particularly, to such schemes that involve private keys resident in devices.

Traditionally in media delivery schemes, a media vendor (“vendor”) may supply (or cause to be supplied) to an end user decoder hardware for decoding encrypted media information that may be typically sent over a single transmission medium. The hardware may be specifically manufactured by the vendor by a partner manufacturer (“manufacturer”), who may embed a private key (which is a shared secret with the vendor) in the hardware for use in decrypting the media information. Special-purpose set-top boxes for receiving encrypted cable or satellite television from a vendor may be one example of such a typical arrangement.

Recently, hybrid networked media products have begun to appear that may receive media information via a variety of different transmission paths and/or transmission media. Also, newer “content everywhere” models for usage and/or consumption of media information have begun to appear. Such newer hybrid devices that may support more than one vendor, and/or the availability of some media information via other paths that that preferred by a given vendor (e.g., Internet-based content), may not be well served by typical media security schemes.

### BRIEF DESCRIPTION OF THE DRAWINGS

The accompanying drawings, which are incorporated in and constitute a part of this specification, illustrate one or more implementations consistent with the principles of the invention and, together with the description, explain such implementations. The drawings are not necessarily to scale, the emphasis instead being placed upon illustrating the principles of the invention. In the drawings,

FIG. 1 conceptually illustrates a media receiving system;

FIG. 2 illustrates a portion of a security module in the system of FIG. 1;

FIG. 3 illustrates an exemplary cypto module in the security module of FIG. 2;

FIG. 4 illustrates an exemplary process of enabling dual use of a private key.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of the claimed invention. However, it will be apparent to those skilled in the art having the benefit of the present disclosure that the various aspects of the invention claimed may be practiced in other examples that depart from these specific details. In certain instances, descriptions of well known devices, circuits, and methods are omitted so as not to obscure the description of the present invention with unnecessary detail.

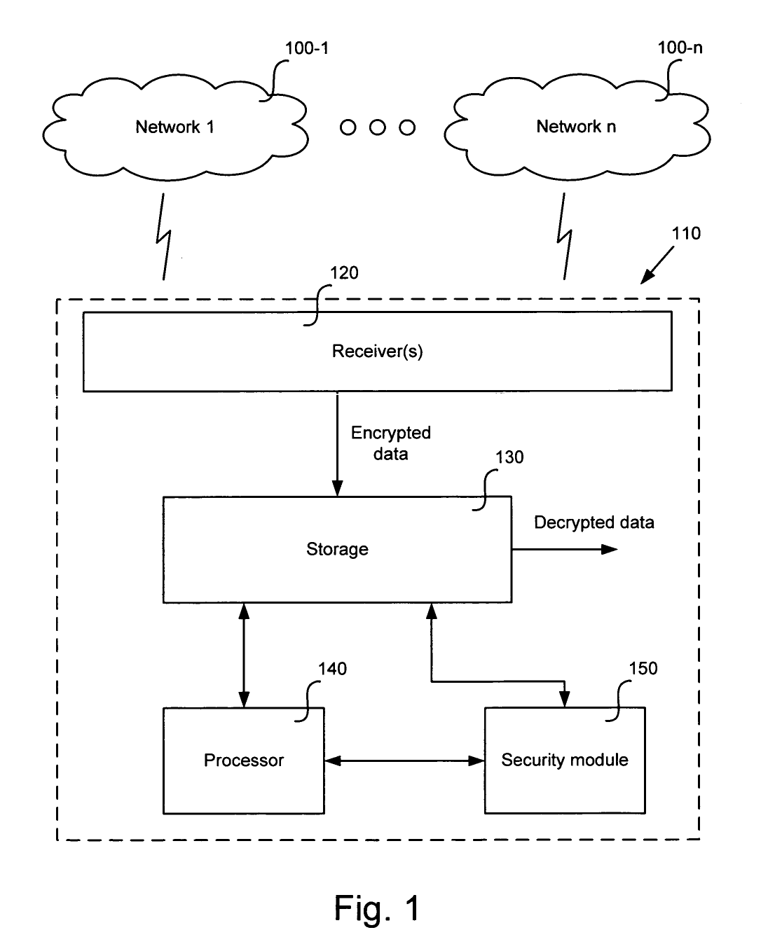

FIG. 1 illustrates a media receiving system. The system may include one or more networks 100-1, . . . , 100-n (collectively “networks 100”) to which a device 110 is communicatively connected. Device 110 may receive encrypted media information via any or all of networks 100 via any suitable medium, including but not limited to various wireless/wired transmission and/or storage media. The media information may include, but is not limited to, video, audio, software, graphical information, television, movies, music, financial information, business information, entertainment information, communications, or any other media-type information that may be provided by a vendor and consumed by an end user.

Device 110 may include one or more receivers 120, storage 130, processor 140, and security module 150. Although illustrated as separate functional elements for ease of explanation, any or all of the elements of device 110 may be co-located and/or implemented by a common group of gates and/or transistors. For example, two or more of elements 120-150 may be implemented in a system on a chip (SOC). Further, device 110 may be implemented via software, firmware, hardware, or any suitable combination thereof. The implementations are not limited in these contexts.

Receivers 120 may be arranged to receive encrypted media information from a variety of transmission paths. Receivers 120 may include, for example, a wireless transceiver (e.g., for Bluetooth, WiFi, WiMax, or any other suitable high-speed wireless protocol), a wired transceiver (e.g., for Ethernet, coaxial cable, etc.), an optical transceiver, a satellite transceiver, and/or any other known circuitry for extracting a signal from a physical transmission medium or storage medium. Receivers 120 also may include any other circuitry for extracting a media information stream from a received signal. Such circuitry may include but is not limited to, for example, demodulators, tuners, equalizers, etc.

Although not illustrated as being directly connected to processor 140 for ease of presentation, receivers 120 may be controlled or otherwise facilitated by processor 140. Receivers 120 may output one or more distinct chunks or streams of encrypted media information to storage 130.

Storage 130 may be arranged to temporarily store chunks and/or streams of encrypted (or in some implementations decrypted) media information. Storage 130 may include, for example, semiconductor and/or magnetic storage, and may be rewritable. In some implementations, storage 130 may include non-writable memory, such as read-only memory (ROM) (e.g., a boot ROM). In some implementations, storage 130 may include memory that is not readable by software, such as one or more hardware private keys set by the manufacturer of device 110. In other implementations, however, such private keys may be stored in security module 150.

Storage 130 may also be arranged to temporarily store information from the vendor that is not strictly media information. For example, in some implementations storage 130 may store run time keys or control words (i.e., sent from the vendor and updateable, as opposed to resident in hardware on device 110). In some implementations, storage 130 may also temporarily store encryption products or other security-related data from security module.

In some implementations, processor 140 may use a result from security module 150 to decrypt encrypted media information from receivers 120 “on the fly” before it is stored in storage 130. In such implementations, storage 130 may temporarily store decrypted media information. In other implementations, encrypted media information my be stored in storage 130 and decrypted when it is read out. Regardless of when the media information is decrypted, it may be output from storage 130 to another portion of device 110, such as a hard disk, display buffer, media-specific processor, etc. (not shown) for further processing or playback.

Processor 140 may be arranged to control the input and output of media information to/from storage 130 and/or security module 150. Processor 140 may also be arranged to decrypt encrypted media information, before or after residing in storage 130, using a decryption key from security module 150. In some implementations, processor 140 may protect access to other processes and/or communication flows in device 110 using the same or other decryption keys from security module 150. For example, using one or more keys from module 150, processor 140 may encrypt or otherwise control access to: booting device 110 (e.g., secure booting), a hard disk, universal serial bus (USB) traffic, TCP/IP traffic, or any other data path originating in or involving device 110.

Security module 150 may be arranged to store one or more private keys that are secret to at least the manufacturer of device 110. One or more of the private keys in security module 150 may be shared secrets between the manufacturer and a number of different vendors. In addition to different, hardware-based private keys, security module 150 may include a number of different cryptographic (“crypto”) modules so that device 110 may provide media decryption, encryption, and/or media security for a number of different vendors than may provide encrypted media over a number of different data paths.

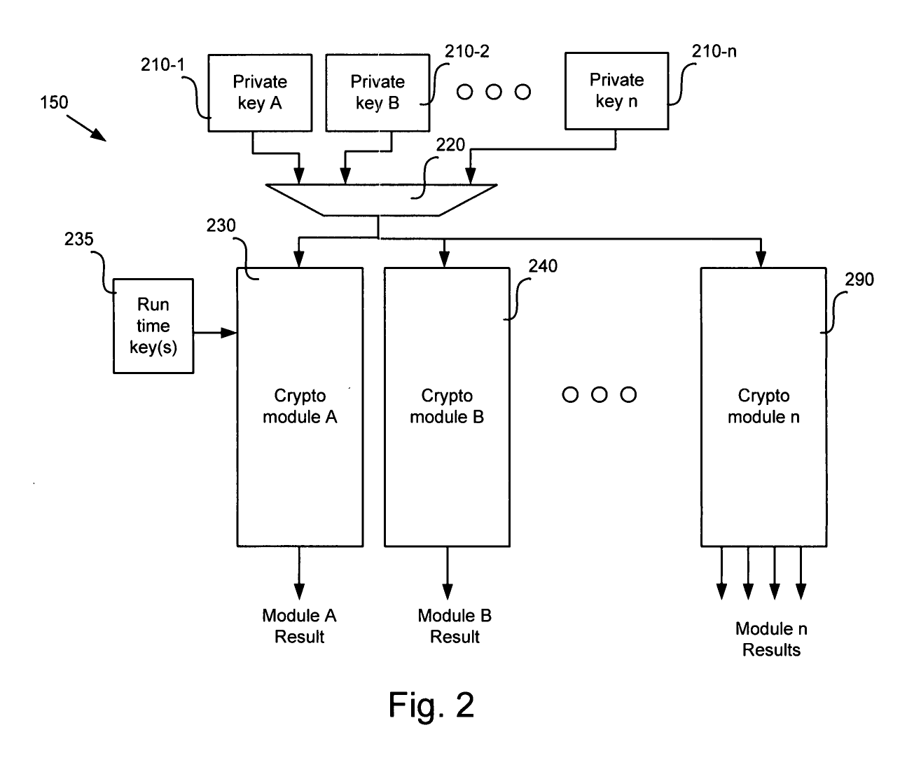

FIG. 2 illustrates at least a portion of security module 150 in an implementation consistent with the principles of the invention. Module 150 may include private keys 210-1, 210-2, . . . , 210-n (collectively “private keys 210”), a multiplexer 220, a first crypto module 230, run time key(s) 235, a second crypto module 240, other crypto modules (not shown), and an nth crypto module 290. Although private keys 210 and the various crypto modules 230-290 may be similarly illustrated, they may be differently implemented, and their details may be defined by different vendors (sometimes known as conditional access (CA) vendors).

Private keys 210 may reside in an externally unreadable (i.e., secure) circuit location within module 150, and may be shared secrets between the manufacturer of device 210 (or at least of the portion containing security module 150) and two or more vendors. Only the manufacturer need be a party to the secret for each private key 210; the vendors need not have knowledge of any other private key 210 than their own. Also, one or more of private keys 210 may be secret to the manufacturer only.

Multiplexer 220 may be arranged to input one or more of private keys 210 to a particular crypto module, such as module 230. In a time-multiplexed manner, for example, multiplexer 220 may input different private keys 210, different combinations of keys 210, and/or the same key 210 to each of crypto modules 230-290. For example, in implementations where a given crypto module 240 is vendor-specific, only the vendor's private key (e.g., key 210-1) may be input thereto. This does not prohibit, however, multiplexer 220 inputting the vendor's private key (e.g., key 210-1) to another crypto module (e.g., module 290) that is arranged by the manufacturer of device 110 for another purpose than the one intended by vendor for private key 210-1.

First crypto module 230 may receive a private key 210, and may use this key 210 to encrypt certain data within module 230. In some implementations, this other data encrypted (or protected) by private key 210 may include one or more run time key(s) 235 that are sent (and possibly updated from time to time) by the vendor associated with first module 230. In some implementations, however, run time keys 235 may not be supplied, and module 230 may encrypt certain predefined data within it (e.g., manufacturer identifiers, etc.) with its private key 210. Again, module 230 may in some implementations encrypt with two or more private keys 210. First crypto module 230 may output a result for use by processor 140 in, for example, decrypting encrypted media information.

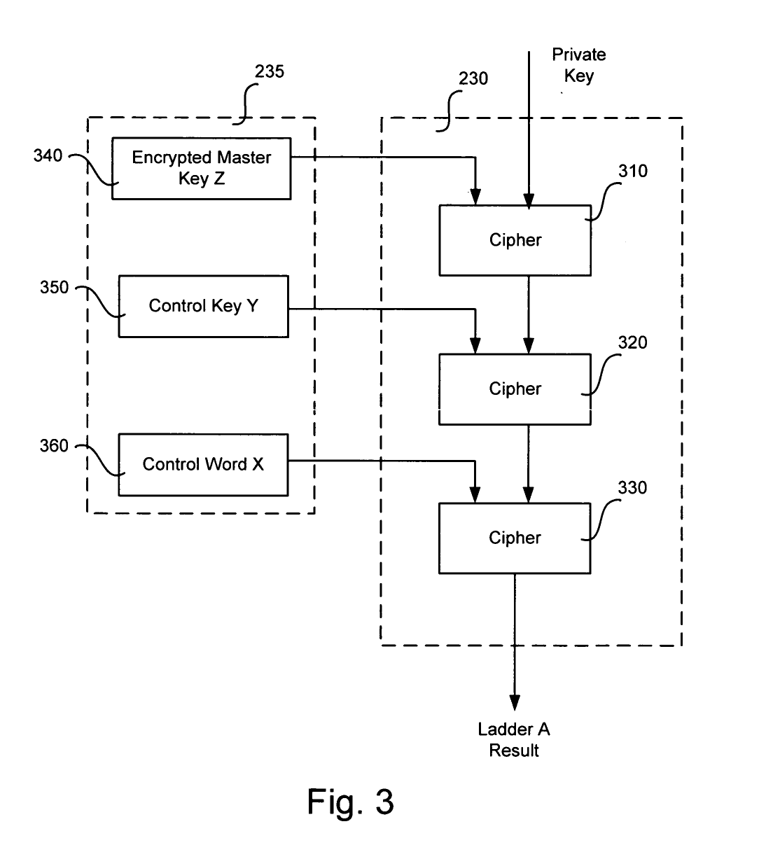

FIG. 3 illustrates an exemplary implementation of first cypto module 230 and run time keys 235. First crypto module 230 may include cipher blocks 310-330, and run time keys 235 may include an encrypted master key 340, a control key 350, and a control word 360. In such implementation, module 230 and keys 235 may be referred to as a “tiered key ladder,” because of the “ladder” of successive encryptions performed by cipher blocks 310-330.

This key ladder scheme may involve the private key being a shared secret with the vendor of media information. The vendor may also supply run time keys 340-360 that are encrypted by the shared secret private key via cipher blocks 340-360. The run time keys 235 may be decrypted by processor 140 and stored in module 150 such that the effective run time keys 340-360 are not visible outside of security module 150 (e.g., “off chip”). The run time key encryption process may include more than one layer of encryption and more than one externally supplied value.

For a 3-tiered example illustrated in FIG. 3, Control Word 360, CWx, may be encrypted with Control Key 350, CKy by cipher 330 to create an external value EncCW=E(CWx, CKy). Cipher 330 (and other ciphers 310 and 320) may employ any of a number of hardware-based encryption schemes, such as DES (Data Encryption Standard), AES (Advanced Encryption Standard), etc. Ciphers 310-330 need not all employ the same encryption algorithm, key length, etc., although they may. This external value EncCW may be the output of module 230. Likewise CKy 350 may be encrypted with the Master Key 340, MKz, by cipher 320 to create the external value EncCK=E(CKy, MKz). Similarly MKz 340 may be encrypted with the Private Key, PKa and to create the external value EncMKz=E(MKz, PKa). Although not explicitly illustrated in FIG. 3, EncCK and/or EncMKz may be stored or otherwise used beyond module 150. This type of tiered, key ladder implementation may provide multiple levels of indirection and protection from attacks.

Returning to FIG. 2, second crypto module 240 may, in some implementations, include a key ladder similar to that shown in FIG. 3 and may use a different private key 210 from another vendor than the one first module 230 does. In such implementations, for example, second module 240 may be associated with a second set of run time keys (not shown) from a second vendor. Such may enable second module 240 to produce a result that decrypts a second stream of media information, from a second vendor, in addition to the information from the first vendor that may be decrypted via, for example, first module 230.

In some implementations, it may be desirable to support more than one private key 210 so that module 150 may have multiple independent shared secrets 210 sharing common key ladders 230/240. It should be noted that the depth of each key ladder does not have to be equal and in some cases intermediate values within the tiers of the key ladder may also be output and used. See, for example, the multiple outputs of module 290 as an example of intermediate values being output. Multiple results output by one module, such as module 290, or different, single results output by different modules 230-290, may isolate cryptographic attacks (even successful ones) against one key ladder (or portion thereof) from another key ladder (or portion thereof).

In some implementations, a private key 210 may be used for independent purposes. For example, private key 210-1 may be used by first module 230 to generate a result for decrypting media information. Private key 210-1 may also be used by, for example, second module 240 or any or all of the modules up to and including nth module 290 to generate a result for decrypting or some other manufacturer-chosen purpose (e.g., for secure booting of device 110). In some implementations, the same private key 210-1 may be used by multiple ones of modules 230-290 for similar or different purposes, all of which may be protected by private key 210-1.

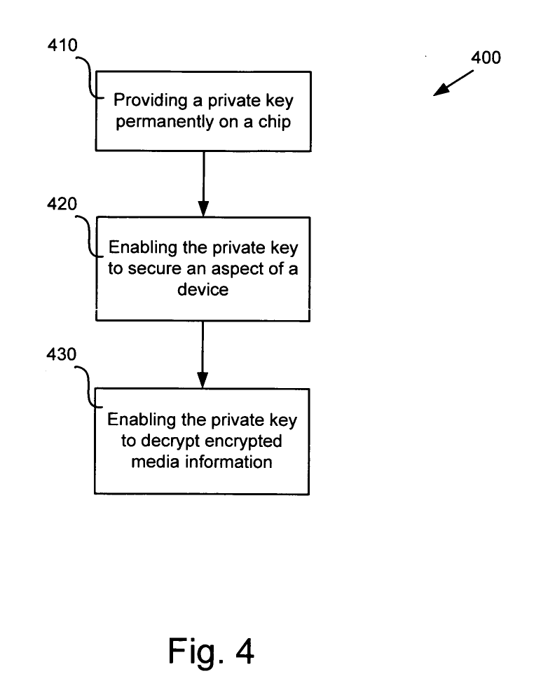

FIG. 4 illustrates an example process 400 of determining an enabling dual use of a vendor-supplied private key 210. Although FIG. 4 may be described with regard to FIGS. 1-3 for ease and clarity of explanation, it should be understood that process 400 may be performed by other hardware and/or software implementations.

Process 400 may begin by the manufacturer of module 150 providing a private key 210 permanently on the hardware that constitutes module 150 [act 410]. Such private key 110 may be inaccessible outside of module 150, and may be a shared secret with a vendor of encrypted media information. In some implementations, act 410 may include providing multiple private keys 410 that are shared secrets with different vendors and/or private key(s) that are secret with the manufacturer of module 150 only.

Process 400 may continue enabling the private key 210 to secure an aspect of device 110 [act 420]. In some implementations, act 420 may include the manufacturer of security module 150 or device 110 providing crypto module 290, with or without associated run time keys 235, in security module 150, because module 290 may enable private key 210 to be used to secure some aspect of device 110 by module 290's operation on private key 210 to produce one or more encrypted results. Such results from module 290 may be used by processor 140 for secure booting device 110, controlling access to storage (e.g., a hard disk) in device 110, and/or securing any data flow in device 110 (e.g., USB, TCP/IP, etc.). Merely providing crypto module 290 (which may include a key ladder) in this sense “enables” private key 210 to secure an aspect of device 110 in act 420.

Process 400 may continue enabling the private key 210 to decrypt encrypted media information [act 430]. In some implementations, act 430 may include the manufacturer of security module 150 or device 110 providing another crypto module 230, with or without associated run time keys 235, in security module 150, because module 230 may enable private key 210 to be used to secure some aspect of device 110 by module 230's operation on private key 210 to produce one or more encrypted results. Such results from module 230 may be used by processor decrypting encrypted media information in storage 130. Merely providing crypto module 230 (which may include a key ladder) in this sense “enables” private key 210 to decrypt encrypted media information in act 430.

The foregoing description of one or more implementations provides illustration and description, but is not intended to be exhaustive or to limit the scope of the invention to the precise form disclosed. Modifications and variations are possible in light of the above teachings or may be acquired from practice of various implementations of the invention.

For example, although “vendors” of media information have been referred to as providing the private keys discussed herein, the private keys may instead be provided by the rights owners of such information, and the media information may actually be provided by a “distributor” or other entity in a business relationship with the owner of the content. As used herein, the term “vendor” is intended to be broadly applied to any entity involved with distributing the encrypted media information and associated, even tangentially, with the private keys.

In a similar vein, “manufacturer” is intended to denote a party associated with providing at least security module 150, and who is a party to a shared-secret private key. For example, different entities may in fact make module 150 and other parts of device 110. As used herein, the term “manufacturer” may apply to any of these entities.

Further, at least some of the acts in FIG. 4 may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Variations and modifications may be made to the above-described implementation(s) of the claimed invention without departing substantially from the spirit and principles of the invention. All such modifications and variations are intended to be included herein within the scope of this disclosure and protected by the following claims.

What is claimed:

1. A security module, comprising:
first circuitry to hold a first private key associated with a first vendor of first media information;
a first cryptographic module to operate on the first private key to generate a first result for decrypting the first media information; and
a second cryptographic module to operate on the first private key to generate a second result.

2. The security module of claim 1, further comprising:
a multiplexer arranged to provide one or more private keys to the first and second cryptographic modules.

3. The security module of claim 1, wherein the first cryptographic module includes:
a first ladder of two or more tiered cipher units to receive the first private key and to generate the first result.

4. The security module of claim 3, further comprising:
first storage to hold two or more run time keys from the first vendor that are inputs to the two or more tiered cipher units in the first ladder.

5. The security module of claim 3, wherein the second cryptographic module includes:
a second ladder of three or more tiered cipher units to receive the first private key and to generate the second result.

6. The security module of claim 5, further comprising:
second storage to hold three or more run time keys that are inputs to the three or more tiered cipher units in the second ladder.

7. The security module of claim 1, further comprising:
second circuitry to hold a second private key associated with a second vendor of second media information;
a third cryptographic module to operate on the second private key to generate a third result for decrypting the second media information.

8. An apparatus, comprising:
circuitry to permanently and inaccessibly store a first private key that is a shared secret between a manufacturer of the circuitry and a first vendor of first encrypted media information;
a key ladder to provide plural layers of encryption to the first private key to generate a first result for decrypting the first encrypted media information; and
a cryptographic module to encrypt the first private key to generate a second result for a security purpose other than decrypting media information.

9. The apparatus of claim 8, further comprising:
a multiplexer arranged to provide the first private key to the key ladder and to the cryptographic module.

10. The apparatus of claim 8, further comprising:
a memory to hold plural run time keys from the first vendor that are inputs to the key ladder.

11. The apparatus of claim 8, further comprising:
a processor to decrypt the first encrypted media information using the first result from the key ladder.

12. The apparatus of claim 8, wherein the purpose other than decrypting is secure booting, securing access to a storage device, or encrypting a data path.

13. The apparatus of claim 8, further comprising:
second circuitry to permanently store a second private key that is associated with a second vendor of second encrypted media information; and
a second cryptographic module to encrypt the second private key to generate a second result for decrypting the second encrypted media information.

14. A system to decrypt media information from different vendors, comprising:
at least one receiver to receive first encrypted media information and second encrypted media information from different vendors;
storage to store at least a portion of the first encrypted media information and second encrypted media information;
a security module to generate a first decryptor and a second decryptor, including:
circuitry to store plural private keys respectively associated with the different vendors,
a first crypto module associated with one of the different vendors to generate the first decryptor using one of the plural private keys, and
a second crypto module associated with another of the different vendors to generate the second decryptor using another one of the plural private keys; and
a processor to decrypt the first encrypted media information using the first decryptor and to decrypt the second encrypted media information using the second decryptor.

15. The system of claim 14, wherein the at least one receiver includes:
a first receiver to receive the first encrypted media information from a first transmission medium, and
a second receiver to receive the second encrypted media information from a second transmission medium that is different from the first medium.

16. The system of claim 14, wherein the first crypto module includes:
a ladder of plural cipher blocks to encrypt the one private key using plural run time keys supplied by the one vendor.

17. The system of claim 14, wherein the security module includes:
a multiplexer to pass the plural private keys to the first crypto module and the second crypto module.

18. A method of enabling dual use of a private key, comprising:
providing a private key permanently on a chip;
enabling the private key to secure an aspect of a device; and
enabling the private key to decrypt encrypted media information.

19. The method of claim 18, wherein the enabling the private key to secure includes:
providing a first key ladder on the chip to encode the private key to produce a result; and
providing a processor to use the result to secure the aspect of the device.

20. The method of claim 18, wherein the enabling the private key to decrypt includes:
providing a first key ladder on the chip to encode the private key to produce a result; and
providing a processor to use the result to decrypt encrypted media information.
